(19) United States
(12) Patent Application Publication
(10) Pub. No.: US 2006/0185215 A1
(43) Pub. Date: Aug. 24, 2006

(54) Landing net with filled handle

(75) Inventor: Grant Corbett, Bend, OR (US)

Correspondence Address: MILLER NASH LLP, 4400 TWO UNION SQUARE, 601 UNION STREET, SEATTLE, WA, 98101-2352, US

(73) Assignee: M Works Corporation

(21) Appl. No.: 11/324,871

(22) Filed: Jan. 3, 2006

Related U.S. Application Data
(60) Provisional application No. 60/655,173, filed on Feb. 22, 2005.

(51) Int. Cl. A01K 77/00

(52) U.S. Cl. 43/11; 43/7

(57) ABSTRACT

The present invention relates to a landing net for use in sport fishing and, more specifically, to a landing net having a filled handle providing desirable flotation and strengthening properties.

### CROSS-REFERENCE TO RELATED APPLICATION

This application claims priority from U.S. Provisional Application No. 60/655,173, filed Feb. 22, 2005. The benefit of the filing date of this application is hereby claimed, and the disclosure of said provisional application is hereby incorporated herein by reference.

### BACKGROUND OF INVENTION

1. Field of Invention

The present invention relates to a landing net for use in sport fishing and, more specifically, to a landing net having a filled handle providing desirable flotation and strengthening properties.

2. Background

Fishermen commonly use landing nets in sport fishing to bring a fish into the boat or out of the water to ensure that the fish does not get away or the line on which the fish is hooked does not break.

Landing nets are available in a variety of sizes. Landing nets are also available in a wide variety of materials. However, most landing nets today consist of a hollow aluminum or carbon fiber shaft, to which is attached a tubular member shaped approximately into a hoop. A net is attached to the hoop-shaped tubular member, and is sized appropriately for the type of fish being caught.

When landing a fish, the fisherman is often trying to accomplish several tasks at once. On the one hand, the fisherman is trying to guide the hooked fish into the net. At the same time he must also hold the net steady, and not permit the line on which the fish is hooked to run back into the water. Predictably, it is not unusual for fishermen to drop a landing net while trying to accomplish these tasks.

Most landing nets currently sold in the United States will sink if dropped into the water. This is a problem from many perspectives. From an environmental perspective, aquatic and marine creatures may become entangled in a landing net that sinks in the water. From a safety perspective, when attempting to land a fish, a fisherman who drops his or her landing net into the water is likely to impulsively attempt to retrieve the landing net. If the landing net quickly sinks in the water, the fisherman may have to reach deep into the water, which could result in the capsizing of a boat and/or the fisherman falling into the water.

Other types of floating nets, not specifically landing nets, are known in other areas of sport fishing. These floating nets are generally created by having a plastic or aluminum handle, which is sealed so as to prevent the entry of water and to create an air pocket that provides flotation. This method of providing flotation, however, is not desirable or effective for landing nets. Even a small hole anywhere along the landing net handle can allow entry of water, which will make the landing net difficult to use when netting a fish due to excessive weight, will make the landing net sink if dropped, and will result in water slowly leaking back out once the landing net is removed from the water and put in a boat or car.

### BRIEF SUMMARY OF THE INVENTION

The present invention relates to a landing net and, more specifically, to a landing net having a filled handle providing desirable flotation and strengthening properties.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a drawing showing an exemplary side perspective view of a landing net of the present invention.

FIG. 2 is a drawing showing an exemplary front perspective view of a landing net of the present invention.

FIG. 3 is a drawing showing an exemplary interior perspective of the handle of the landing net of the present invention.

FIG. 4 is a drawing showing an exemplary interior perspective of the connection between the handle and the hoop-shaped tubular member of the landing net of the present invention.

FIG. 5 is a drawing showing an exemplary top interior perspective view of the connection between the handle and the hoop-shaped tubular member of the landing net of the present invention.

FIGS. 6-8 are drawings showing exemplary interior perspective views of the handle of the landing net of the present invention.

FIGS. 9-10 are drawings showing an exemplary top interior perspective view of the handle of the landing net of the present invention.

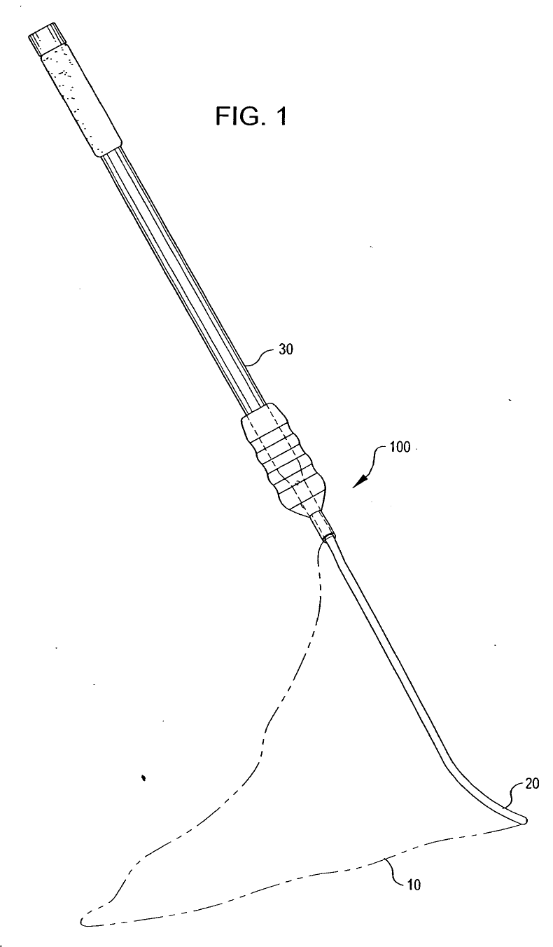

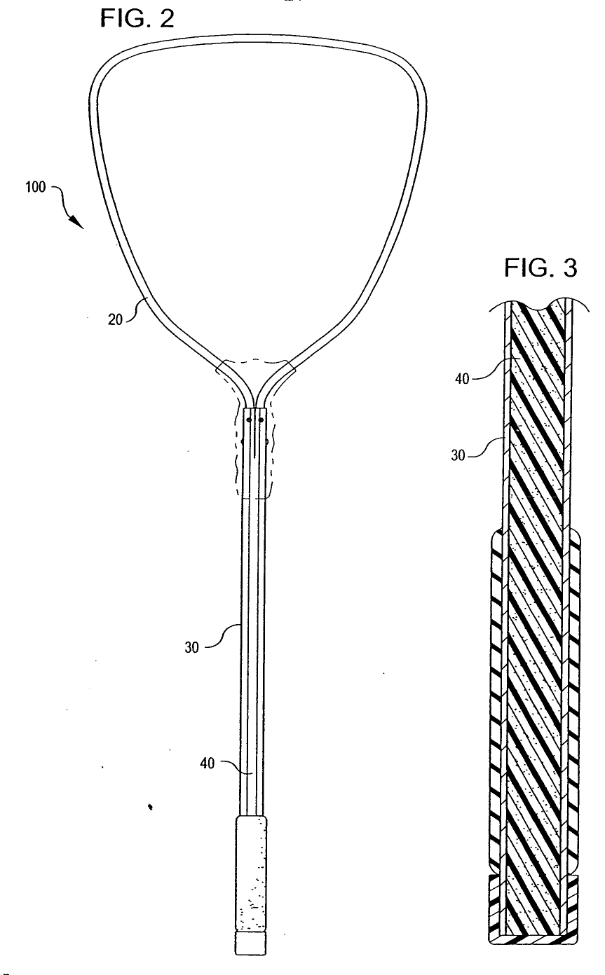

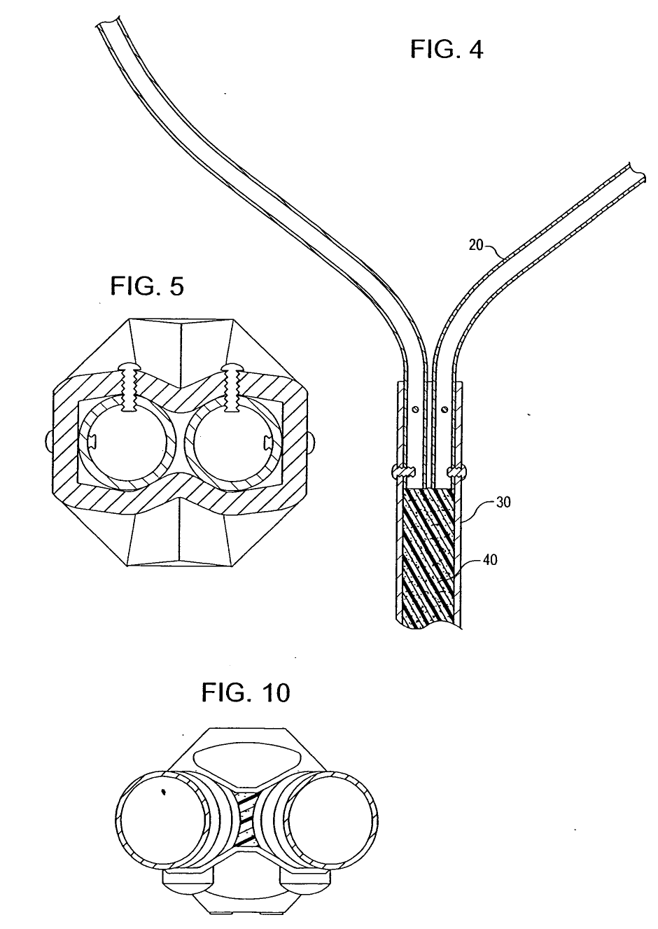

### DETAILED DESCRIPTION OF THE INVENTION

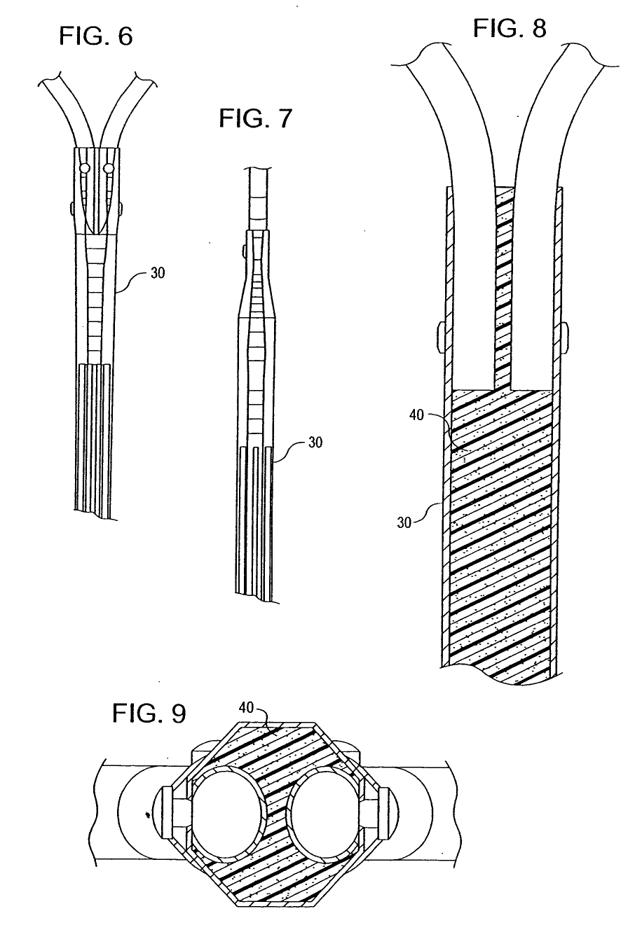

The present invention is a landing net 100 comprising a net 10 framed on a hoop-shaped tubular member 20, which is attached to a hollow shaft 30 that serves as a handle for the net. The hollow shaft 30 can be circular, elliptical, or rectangular in axial cross section, or can be any other shape convenient for forming a handle 30. At least a portion of the hollow shaft 30 is filled with closed-cell foam, cork, balsa wood, air bladder insert and any other composite material used to create flotation (collectively referred to as “core material”), which provides flotation and strengthening characteristics to the handle 30. Open-cell foam is also an element that is known in the industry and may be used to fill a hollow shaft, although open-cell foam is not claimed as part of this invention. FIGS. 5-14 show various exemplary embodiments and views of the landing net 100 of the present invention.

While this detailed description is directed to larger nets intended for fish weighing from half a pound to sixty pounds, construction of similar nets for smaller or larger fish would be practicable and nothing in this detailed description should limit the size of the landing net 100 or use of the present invention with varying fish sizes or weights.

Although the hollow shaft 30 of the present invention may be any shape, in a preferred embodiment, the hollow shaft 30 is octagonally shaped. An octagonally shaped hollow shaft 30 increases the structural rigidity of the hollow shaft 30 as well as the strength of the landing net 100. Further, an octagonally shaped hollow shaft 30 allows for a more thinly gauged exterior wall of the hollow shaft 30, which reduces the weight of the hollow shaft 30 and provides a lighter landing net 100.

In a second preferred embodiment, the entire length of the hollow shaft 30 is filled with a core material 40. The core material 40 not only provides buoyancy, but also has sufficient strength and density to provide additional rigidity to the hollow shaft 30. The increased rigidity of the hollow shaft 30 improves the handling characteristics of the landing net 100 for its intended purpose. In one example of this second preferred embodiment, the hollow shaft 30 has a length of 48 inches, and the hoop-shaped tubular member 20 measures 24 inches wide by 29 inches long.

A third preferred embodiment of the landing net 100 of the present invention involves fabricating a hollow shaft 30 from a carbon fiber material, as is generally well known to those of ordinary skill in the art. A hollow shaft 30 made from carbon fiber provides a more rigid, potentially lighter hollow shaft 30. The hollow shaft 30 made from carbon fiber may be filled with core material 40, either partially or completely, to provide buoyancy and additional rigidity.

Various types of core material 40 can be used to accomplish the invention, all of which are well known to those of ordinary skill in the art, although it is preferred that a closed-cell foam be used as the core material 40 in connection with the present invention. Exemplary types of closed-cell foam 40 that may be used in connection with the present invention including, but not limited to polyurethane foam, are manufactured by companies such as Dow Chemical Company and Stepan Company.

The core material 40 may be disposed inside the hollow shaft 30 in one of several ways well known to those of ordinary skill in the art. In a first exemplary embodiment, the core material 40 is cut or otherwise formed into a shape with dimensions matching the inside of the hollow shaft 30 constituting the handle of the net. The core material 40 may then be inserted within the hollow shaft 30 and fixed using waterproof glue or any other well known methods of affixing a core material 40 inside a hollow shaft 30.

In a second exemplary embodiment and depending on the type of core material 40 used in connection with the present invention, one end of the hollow shaft 30 is first sealed with a sealant. Preferably, the sealed end of the hollow shaft 30 will be the end in which the hoop-shaped tubular member 20 has been inserted or otherwise affixed. The core material may then be disposed inside the hollow shaft in any manner befitting the specific core material used. For example, if the core material is closed-cell foam, a foam-forming liquid may be injected into the hollow shaft 30. The foam-forming liquid is permitted to expand to fill the entire hollow shaft 30 with closed-cell foam 40. This method avoids the need to then affix the closed-cell foam 40 to the inside of the hollow shaft 30.

A landing net 100 with a core material 40 filled hollow shaft 30 as described above can be fabricated in such a way that the core material 40 prevents water from filling part or all of the hollow shaft 30. The core material 40 provides sufficient buoyancy to cause the landing net 100 to float if dropped in the water.

If the core material 40 fills the entire void in the hollow shaft 30, the core material 40 should prevent water from entering into and remaining in the hollow shaft 30. In addition to other benefits listed herein, a landing net 100 constructed in this manner should not retain water, which eliminates the problem of trapped water dripping or leaking from the landing net 100 out onto the floor of a boat, vehicle, or storage area.

An appropriately chosen core material 40, such as the exemplary cell-foams described above, can strengthen the hollow shaft 30 of the landing net 100, making it more rigid. This quality of cell-foams results in a landing net 100 that has a more “balanced feel” in the fisherman's hand, without the addition of significant and undesirable weight. Such a landing net 100 is easier for a fisherman to handle and control.

In addition to the other advantages described above, the landing net 100 of the present invention is a quieter net than others sold in the industry. The core material 40 of the landing net 100 of the present invention dampens the sound that results from hitting the landing net 100 against, for example, a side of a boat when trying to land a fish. In addition, the landing net 100 of the present invention is quieter when dropped to the floor of a boat, car, or other vehicle. The noise-dampening effect of the core material 40 produces a more desirable landing net 100, in part because the lower level of noise is less likely to spook a fish, less likely to interrupt or irritate other fisherman in the area, and because the landing net 100 is less noisy to handle when being stored or transported.

Further, the landing net 100 of the present invention is beneficial to the environment. Because the landing net 100 does not sink to the bottom of a lake or ocean, entanglement of the landing net 100 with aquatic and marine creatures will be avoided. Also, from a safety perspective, when using the landing net 100 of the present invention to land a fish, the floating nature of the landing net 100 will allow a fisherman to avoid impulsively retrieving the fallen landing net 100 in the water, which could result in the capsizing of a boat or the fisherman falling in the water.

Additionally, the landing net 100 of the present invention may also be beneficial in that, if a fish has landed in the landing net 100, and if the landing net 100 is subsequently dropped into the water, it is more difficult for a fish to escape from the landing net 100 floating on the water than a net that has sunk into the water. The buoyance of the landing net 100 of the present invention may counteract a fishes ability to retreat into the water.

Other advantages and details about the landing net 100 of the present invention are detailed in the accompanying drawings.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A landing net, said landing net comprising:
(a) a hollow shaft having a near end and a distal end;
(b) a core material disposed inside at least part of the length of the hollow shaft;
(c) a tubular member formed into a hoop-like shape for holding a net, the tubular member disposed on the distal end of the shaft; and
(d) a net framed upon the tubular member.

2. The landing net of claim 1, in which the core material is disposed inside the entire length of the hollow shaft.

3. The landing net of claim 1, in which the core material is chosen from a group consisting of:
(a) closed-cell foam;
(b) cork;
(c) balsa wood;
(d) air bladder insert; and
(e) a composite material creating flotation.

4. The landing net of claim 1, in which the hollow shaft is composed from a group consisting of:
(a) aluminum;
(b) carbon fiber; and
(c) plastic.

5. The landing net of claim 1, further comprising a sealing member at each end of the shaft to create a watertight sealant to prevent entry of water into the shaft.

6. The landing net of claim 1, in which the core material provides sufficient additional rigidity to the hollow shaft to provide decreased flexing and improved ability to control the net when holding it at the near end of the hollow shaft.

7. A method for manufacturing a landing net, said method comprising the steps of:
(a) cutting or otherwise forming a hollow shaft to a predetermined desired length, the hollow shaft having a near end and a distal end;
(b) inserting a first end and a second end of a tubular hoop-like member to which a net has been attached into the distal end of the hollow shaft;
(c) fixing the first end and the second end of the tubular hoop-like member to the distal end of the hollow shaft;
(d) sealing the distal end of the hollow shaft with a sealing agent;
(e) disposing a foam-forming liquid inside the hollow shaft; and
(f) permitting the foam-forming liquid to fill the hollow shaft with the resulting foam.

8. A method for manufacturing a landing net, said method comprising the steps of:
(a) cutting or otherwise forming a hollow shaft to a predetermined desired length, the hollow shaft having a near end and a distal end;
(b) inserting a first end and a second end of a tubular hoop-like member to which a net has been attached into the distal end of the hollow shaft;
(c) fixing the first end and the second end of the tubular hoop-like member to the distal end of the hollow shaft;
(d) sealing the distal end of the hollow shaft with a sealing agent;
(e) inserting a core material inside the hollow shaft; and
(f) sealing near the end of the hollow shaft.

9. The method of claim 8, wherein the core material is selected from a group consisting of:
(a) closed-cell foam;
(b) cork;
(c) balsa wood;
(d) air bladder insert; and
(e) composite material creating flotation.
